(19) United States
(12) Patent Application Publication
(10) Pub. No.: US 2022/0218560 A1
(43) Pub. Date: Jul. 14, 2022

(54) PROSTATE MASSAGE APPARATUS

(71) Applicants: Man Taek HWANG, Seongnam-si (KR); So Myeong JUNG, Seongnam-si (KR)

(72) Inventors: Man Taek HWANG, Seongnam-si (KR); So Myeong JUNG, Seongnam-si (KR)

(21) Appl. No.: 17/570,657

(22) Filed: Jan. 7, 2022

(30) Foreign Application Priority Data
Jan. 8, 2021 (KR) 10-2021-0002802

(51) Int. Cl. A61H 19/00

(52) U.S. Cl. CPC A61H 19/30; A61H 2205/087; A61H 2201/149; A61H 2201/1215; A61H 2203/0425

(57) ABSTRACT

The present disclosure relates to a prostate massage apparatus including a cushion part on which a user is able to sit, a reciprocating horizontal movement part installed to be horizontally movable along both sides inside the cushion part, an acupressure part installed to be movable upward and downward at an upper end of the reciprocating horizontal movement part and configured to move upward to a pressing position due to an elastic force of an elastic member, and a driving part mechanically connected to the reciprocating horizontal movement part by a power transmission member inside the cushion part and configured to, when driven to rotate, allow the reciprocating horizontal movement part to move back and forth along both sides.

### CROSS-REFERENCE TO RELATED APPLICATION

This application claims priority to and the benefit of Korean Patent Application No. 10-2021-0002802, filed on Jan. 8, 2021, the disclosure of which is incorporated herein by reference in its entirety.

### BACKGROUND

### 1. Field of the Invention

The present disclosure relates a prostate (perineal region) massage apparatus, and more particularly, to a prostate massage apparatus capable of continuously pressing and rubbing a user's prostate (perineal region) to stimulate the same, thus aiding reproductive health.

### 2. Discussion of Related Art

Generally, the prostate (perineal region) is a male reproductive organ that is located below the bladder and secretes prostatic fluid, which is the liquid component of semen.

In recent years, the number of men with genital diseases such as benign prostatic hyperplasia, prostatitis, and prostate cancer has increased significantly. Modern people having a sedentary lifestyle often have their prostate (perineal region) pressed for a long time such that circulation at acupoints is not smooth and are exposed to various genital diseases due to circulation disorders.

Also, in the erection and ejaculation of the penis, muscles of an inner thigh, the bulbocavernous body surrounding the cavernous body of the penis, the sciatic cavernous muscle, the perineal transverse muscle, the external anal sphincter, and the like are involved. It is natural that these muscles also become loose with age and lose their strength if left unattended. Massaging the “perineal region” which is associated with the prostate is very effective in strengthening these muscles. Urologists usually recommend massaging the perineal region 60 times twice a day, after waking up and before bed.

Adult men suffer from genital diseases such as perineal pain, groin pain, and benign prostatic hyperplasia and, to treat such diseases, visit a specialized hospital for professional management, take medicine for prostate treatment, or receive surgery for benign prostatic hyperplasia.

However, when visiting a specialized hospital for prostate massage to treat such diseases, they have to bear the time and cost for treatment, which makes it difficult for them to receive regular care, and have to endure discomfort during prostate examination. Also, an apparatus for prostate massage may not be available in households or hospitals, it is not easy to massage the prostate by hand, and there is no proper treatment method other than taking medicine. Therefore, there is demand for technology related to a massage apparatus that allows a user to, at a desired location, massage the prostate by continuously pressing and rubbing the prostate and that is capable of, through the prostate massage directly pressing and rubbing the prostate, preventing and treating genital diseases.

As the related art of the present disclosure, Korean Patent Publication No. 10-2013-0021122 (Date of Publication: Mar. 5, 2013) discloses a ball mechanism for prostate massage.

### SUMMARY OF THE INVENTION

The present disclosure is directed to providing a prostate (perineal region) massage apparatus capable of continuously pressing and rubbing a user's prostate (perineal region) to stimulate the same, thus helping reproductive health.

One aspect of the present disclosure provides a prostate massage apparatus including a cushion part on which a user is able to sit, a reciprocating horizontal movement part installed to be horizontally movable along both sides inside the cushion part, an acupressure part installed to be movable upward and downward at an upper end of the reciprocating horizontal movement part and configured to move upward to a pressing position due to an elastic force of an elastic member, and a driving part mechanically connected to the reciprocating horizontal movement part by a power transmission member inside the cushion part and configured to, when driven to rotate, allow the reciprocating horizontal movement part to move back and forth along both sides, wherein the acupressure part elastically supports the prostate of the user seated on the cushion part from below, and when the acupressure part moves back and forth along both sides along with the reciprocating horizontal movement part, the height of the acupressure part is changed to press the prostate.

Also, the acupressure part may include a pair of upward/downward movement holes each formed in an upper end of the reciprocating horizontal movement part in a movement direction thereof, an upward/downward movement member including a pair of insertion parts inserted into each upward/downward movement hole so as to be movable upward and downward and a connecting part configured to horizontally connect upper ends of the insertion parts, a pressing member coupled to an outer portion of the connecting part to press the prostate from below, and the elastic member coupled to an outer portion of the insertion part to allow a compressive elastic force to act between the connecting part and the reciprocating horizontal movement part.

Also, an acupressure protrusion configured to press the prostate may protrude from an outer peripheral surface of the pressing member, and the acupressure protrusion may be provided as a plurality of acupressure protrusions arranged to be spaced apart in a direction in which the pressing member moves.

Also, a guide part configured to slidably support an outer portion of the reciprocating horizontal movement part may be further disposed inside the cushion part.

Also, the power transmission member may include a first rotating shaft disposed at one end of the reciprocating horizontal movement part in the movement direction thereof and configured to form a horizontal center of rotation in a width direction of the reciprocating horizontal movement part, a connecting link whose one side is connected to be rotatable in a longitudinal direction of the reciprocating horizontal movement part by the first rotating shaft, a second rotating shaft disposed at the other side that corresponds to the one side of the connecting link and configured to form a horizontal center of rotation so as to be parallel to the first rotating shaft, and an eccentric bar having one side connected to a driving shaft of the driving part that is parallel to the second rotating shaft and the other side, which is eccentric, connected to be rotatable in a rotational direction of the connecting link by the second rotating shaft.

Also, the prostate massage apparatus may further include a controller electrically connected to the driving part to control driving and a power supply part electrically connected to the controller to supply power thereto.

Another aspect of the present disclosure provides a prostate massage apparatus including a cushion part on which a user is able to sit, a swing part whose upper end and lower end are installed to be able to move back and forth and rotate along both left and right sides with respect to a horizontal center of rotation inside the cushion part, an acupressure part installed to be movable upward and downward at an upper end of the swing part and configured to move upward to a pressing position due to an elastic force of an elastic member, and a driving part mechanically connected to the swing part by a power transmission member inside the cushion part and configured to, when driven to rotate, allow the swing part to move back and forth and rotate along both left and right sides, wherein the acupressure part elastically supports the prostate of the user seated on the cushion part from below, and when the acupressure part moves back and forth and rotates along both left and right sides along with the swing part, the height of the acupressure part is changed to press the prostate.

Also, the acupressure part may include an upward/downward movement member coupled to an upper end of the swing part so as to be movable upward and downward, a pressing member coupled to an upper end of the upward/downward movement member to press the prostate from below, and the elastic member coupled to an outer portion of the upward/downward movement member to allow a compressive elastic force to act between the pressing member and the swing part.

Also, an acupressure protrusion configured to press the prostate may protrude from an upper end of the pressing member, and the acupressure protrusion may be provided as a plurality of acupressure protrusions arranged to be spaced apart in a direction in which the pressing member moves back and forth and rotates.

Also, the power transmission member may include a first rotating shaft configured to form a horizontal center of rotation at a lower end of the swing part, a connecting link whose one side is connected to be rotatable in a rotational direction of the swing part by the first rotating shaft, a second rotating shaft disposed at the other side that corresponds to the one side of the connecting link and configured to form a horizontal center of rotation so as to be parallel to the first rotating shaft, and an eccentric bar having one side connected to a driving shaft of the driving part that is parallel to the second rotating shaft and the other side, which is eccentric, connected to be rotatable in a rotational direction of the connecting link by the second rotating shaft.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a perspective view illustrating a prostate massage apparatus according to an embodiment of the present disclosure;

FIG. 2 is a perspective view illustrating a reciprocating horizontal movement part, an acupressure part, and a driving part of the prostate massage apparatus according to an embodiment of the present disclosure in detail;

FIG. 3 is a front cross-sectional view of the prostate massage apparatus according to an embodiment of the present disclosure;

FIG. 4 is a first operational state view illustrating a process in which, in the prostate massage apparatus according to an embodiment of the present disclosure, the driving part is driven to rotate and causes the reciprocating horizontal movement part and the acupressure part to move toward one side;

FIG. 5 is a second operational state view illustrating a state in which, in the prostate massage apparatus according to an embodiment of the present disclosure, the reciprocating horizontal movement part and the acupressure part are moved toward the one side due to the driving part being driven to rotate;

FIG. 6 is a front cross-sectional view illustrating a state in which a connector is connected to a power supply part of the prostate massage apparatus according to an embodiment of the present disclosure;

FIG. 7 is a perspective view illustrating a state in which a roller is installed at a pressing member of the prostate massage apparatus according to an embodiment of the present disclosure;

FIG. 8 is a front cross-sectional view illustrating the state in which the roller is installed at the pressing member of the prostate massage apparatus according to an embodiment of the present disclosure;

FIG. 9 is a front cross-sectional view illustrating a state in which a detecting part is installed in the prostate massage apparatus according to an embodiment of the present disclosure;

FIG. 10 is a perspective view illustrating a prostate massage apparatus according to another embodiment of the present disclosure;

FIG. 11 is a perspective view illustrating a reciprocating horizontal movement part, an acupressure part, and a driving part of the prostate massage apparatus according to the other embodiment of the present disclosure in detail; and

FIG. 12 is a front cross-sectional view of the prostate massage apparatus according to the other embodiment of the present disclosure.

### DETAILED DESCRIPTION OF EXEMPLARY EMBODIMENTS

Hereinafter, exemplary embodiments according to the present disclosure will be described in detail with reference to the accompanying drawings.

Advantages and features of the present disclosure and a method of achieving the same should become clear with embodiments described in detail below with reference to the accompanying drawings.

However, the present disclosure is not limited to embodiments disclosed below and is realized in various different forms. The present embodiments make the disclosure of the present disclosure complete and are provided to completely inform one of ordinary skill in the art to which the present disclosure pertains of the scope of the disclosure. The present disclosure is defined only by the scope of the claims.

In addition, in describing the present disclosure, when detailed description of a known related art is considered as having the possibility of obscuring the gist of the present disclosure, the detailed description thereof will be omitted.

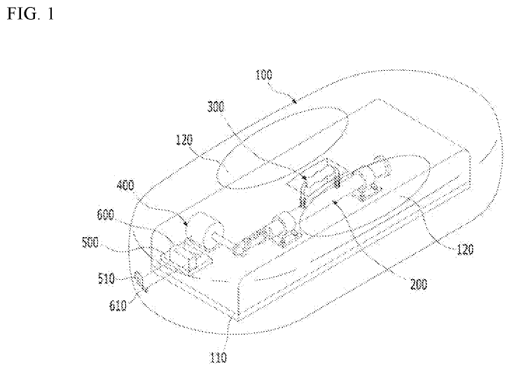

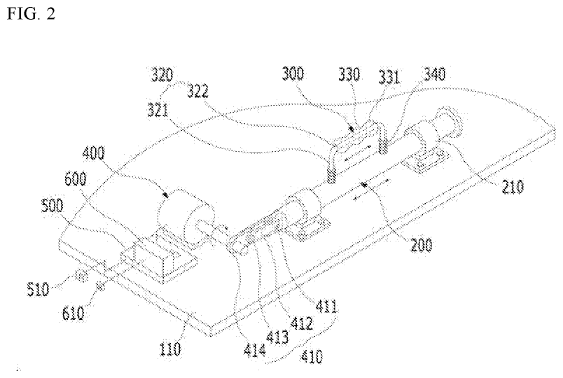

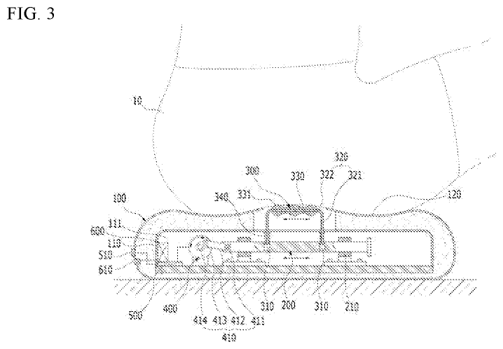

FIG. 1 is a perspective view illustrating a prostate massage apparatus according to an embodiment of the present disclosure, FIG. 2 is a perspective view illustrating a reciprocating horizontal movement part, an acupressure part, and a driving part of the prostate massage apparatus according to an embodiment of the present disclosure in detail, and FIG. 3 is a front cross-sectional view of the prostate massage apparatus according to an embodiment of the present disclosure.

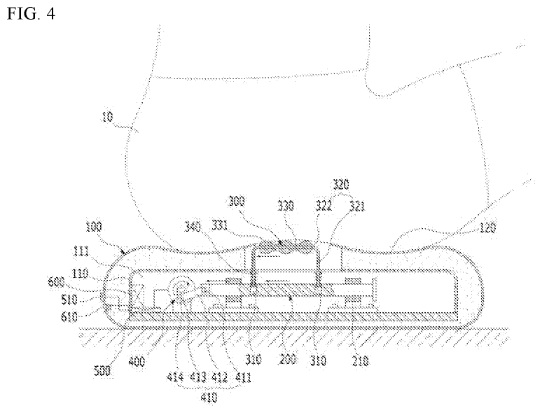

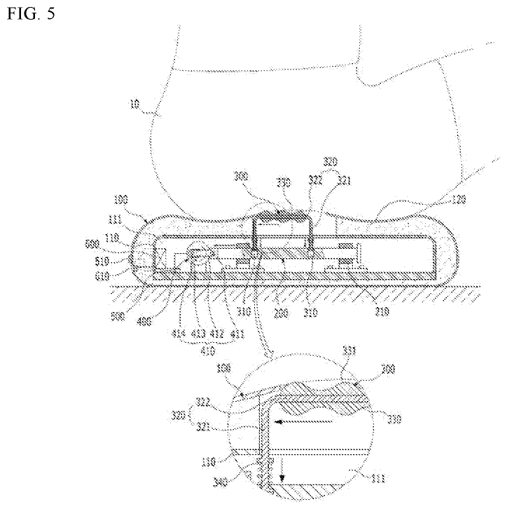

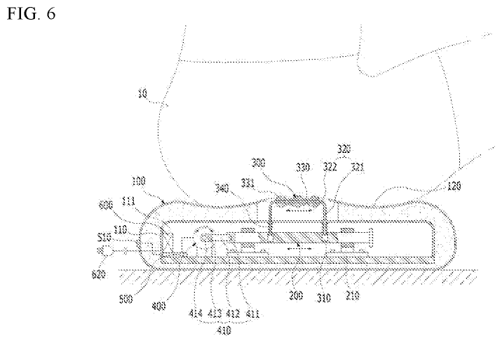

FIG. 4 is a first operational state view illustrating a process in which, in the prostate massage apparatus according to an embodiment of the present disclosure, the driving part is driven to rotate and causes the reciprocating horizontal movement part and the acupressure part to move toward one side, FIG. 5 is a second operational state view illustrating a state in which, in the prostate massage apparatus according to an embodiment of the present disclosure, the reciprocating horizontal movement part and the acupressure part are moved toward the one side due to the driving part being driven to rotate, and FIG. 6 is a front cross-sectional view illustrating a state in which a connector is connected to a power supply part of the prostate massage apparatus according to an embodiment of the present disclosure.

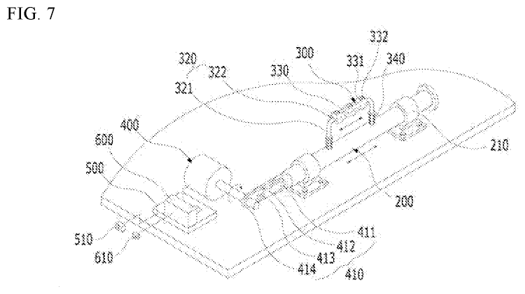

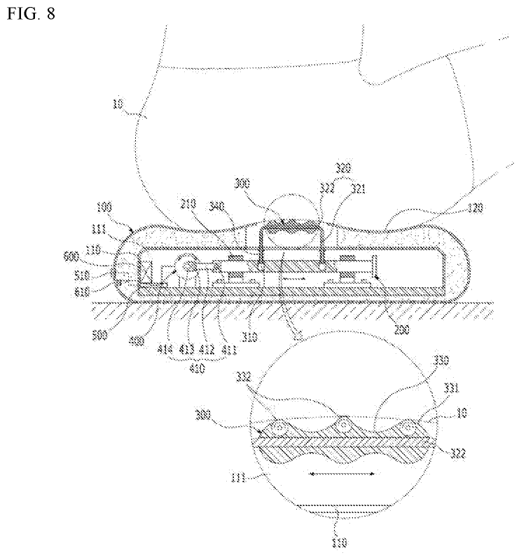

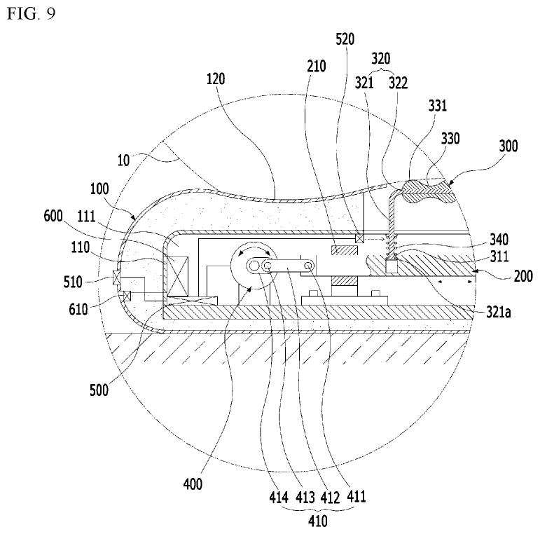

FIG. 7 is a perspective view illustrating a state in which a roller is installed at a pressing member of the prostate massage apparatus according to an embodiment of the present disclosure, FIG. 8 is a front cross-sectional view illustrating the state in which the roller is installed at the pressing member of the prostate massage apparatus according to an embodiment of the present disclosure, and FIG. 9 is a front cross-sectional view illustrating a state in which a detecting part is installed in the prostate massage apparatus according to an embodiment of the present disclosure.

Referring to FIGS. 1 to 9, a prostate massage apparatus according to an embodiment of the present disclosure is for massaging a prostate (perineal region), which is a male reproductive organ, and includes a cushion part 100, a reciprocating horizontal movement part 200, an acupressure part 300, a driving part 400, a controller 500, and a power supply part 600.

The cushion part 100 is formed to have a certain area to allow a user 10 to sit thereon and may be filled with an elastic material (sponge, cotton, etc.) to have an elastic restoration force. An outer cover allowing the cushion part 100 to be coupled or separated may be disposed at an outer portion of the cushion part 100.

Here, an opening/closing part (a zipper, a buckle, etc.) (not illustrated) which is able to be opened and closed may be disposed at the outer cover of the cushion part 100. A space to which a housing 110 may be coupled may be formed inside the cushion part 100, and an installation space 111 may be formed to have a certain area inside the housing 110.

Also, a pair of seating grooves 120 having a shape that corresponds to buttocks of the user may be concavely formed on an upper surface of the cushion part 100 to allow the user to sit thereon. The seating groove 120 may be concavely formed in an elliptical shape, a hemispherical shape, or the like.

Also, an opening may be formed to vertically pass through a gap between the seating grooves 120 to allow a pressing member 330, which will be described below, to be exposed to an upper portion of the cushion part 100. That is, since the pressing member 330, which will be described below, is exposed to an upper portion of the opening, a pressing force of the pressing member 330 may be directly transmitted to the prostate of the user 10.

The reciprocating horizontal movement part 200 is installed to be able to move back and forth along both sides due to a rotational force of the driving part 400, which will be described below, inside the cushion part 100. The reciprocating horizontal movement part 200 may be horizontally installed inside the installation space 111 and may have a length in a movement direction thereof.

Here, a guide part 210 configured to horizontally guide the reciprocating horizontal movement part 200 along both sides may be installed at a bottom surface of the installation space 111, and the guide part 210 may be provided as a plurality of guide parts 210 disposed to be spaced apart in a longitudinal direction of the reciprocating horizontal movement part 200.

Also, the guide part 210 may have a ring shape, the reciprocating horizontal movement part 200 may horizontally pass through the ring-shaped guide part 210, and the reciprocating horizontal movement part 200 supported by the guide part 210 may be disposed above the bottom surface of the installation space 111 so as to be spaced apart therefrom. Also, a ring-shaped bearing (not illustrated) configured to reduce friction may be installed at an inner peripheral surface of the guide part 210. The acupressure part 300 is installed to be movable upward and downward at an upper end of the reciprocating horizontal movement part 200 and configured to move upward to a pressing position due to an elastic force of an elastic member 340 which will be described below. The acupressure part 300 elastically presses the prostate of the user 10 seated on the cushion part 100 from below, and when the acupressure part 300 moves back and forth along both sides along with the reciprocating horizontal movement part 200, the acupressure part 300 moves to press and rub the prostate.

The acupressure part 300 according to an embodiment of the present disclosure may include a pair of upward/downward movement holes 310 each formed in the upper end of the reciprocating horizontal movement part 200 in the movement direction thereof, an upward/downward movement member 320 including a pair of insertion parts 321 inserted into each upward/downward movement hole 310 so as to be movable upward and downward and a connecting part 322 configured to horizontally connect upper ends of the insertion parts 321, a pressing member 330 coupled to an outer portion of the connecting part 322 to press the prostate of the user 10 from below, and the elastic member 340 coupled to an outer portion of the insertion part 321 to allow a compressive elastic force to act between the connecting part and the reciprocating horizontal movement part 200.

The upward/downward movement hole 310 may be vertically formed, and a step may be formed at an inner peripheral surface of the upward/downward movement hole 310 so that a catching protrusion of the connecting part 322 is caught at a position where the catching protrusion is maximally moved upward. The step of the upward/downward movement hole 310 may be formed in an upper region of the upward/downward movement hole 310 so as to prevent the connecting part 322 from being detached through an upper portion.

The insertion parts 321 of the upward/downward movement member 320 have a vertical length at both sides, and a lower end of the insertion part 321 is vertically inserted into the upward/downward movement hole 310 so as to be slidable upward and downward. Here, a catching protrusion that protrudes sideward may be formed on a lower end of the upward/downward movement member 320, and when the upward/downward movement member 320 is maximally moved upward, the catching protrusion may be caught at a lower end of the step formed at the inner peripheral surface of the upward/downward movement hole 310.

The connecting part 322 of the upward/downward movement member 320 has a length along both sides, both ends of the connecting part 322 in the longitudinal direction may be horizontally connected to the upper end of the insertion part 321, and a width direction of the upward/downward movement member 320 may be formed so that the pressing member 330, which will be described below, is able to move back and forth.

The pressing member 330 is coupled to an outer portion of the connecting part 322 and has a hollow formed therein to allow the connecting part 322 to horizontally pass therethrough. The pressing member 330 may have a length in a movement direction thereof.

Also, an acupressure protrusion 331 configured to press the prostate of the user 10 may be formed at an outer peripheral surface of the pressing member 330.

The acupressure protrusion 331 may protrude outward from the pressing member 330 and may be provided as a plurality of acupressure protrusions 331 formed to be spaced apart in a longitudinal direction of the pressing member 330. The acupressure protrusions 331 may be continuously formed in a width direction of the pressing member 330.

Also, protruding ends of the acupressure protrusions 331 may form a convex curvature in a longitudinal direction of the pressing member 330, and portions in between the acupressure protrusions 331 may form a concave curvature.

When an upper end of the pressing member 330 is pressed against the prostate of the user 10 seated on the upper surface of the cushion part 100 and the reciprocating horizontal movement part 200 moves back and forth along both sides, the pressing member 330 massages the prostate of the user 10 while moving in a left-right direction along with the reciprocating horizontal movement part 200. Here, since the acupressure protrusions 331 protruding outward from the pressing member 330 horizontally move back and forth while pressing the prostate of the user 10, it is possible to maximize massage effects.

The elastic member 340 is coupled to an outer portion of the insertion part 321 to allow a compressive elastic force to act between the connecting part and the reciprocating horizontal movement part 200. The elastic member 340 may have the form of a coil spring to allow a compressive elastic force to act in the vertical direction. In this case, the elastic member 340 may have an upper end elastically supporting a lower end of the pressing member 330 and a lower end elastically supporting the upper end of the reciprocating horizontal movement part 200.

A roller 332 which is rotatable with respect to a horizontal center of rotation may be disposed at the upper end of the pressing member 330. The horizontal center of rotation of the roller 332 may be formed in the width direction of the pressing member 330, the roller 332 may be installed to be rotatable in a direction in which the pressing member 330 horizontally moves, and the roller 332 may be provided as a plurality of rollers 332 installed to be spaced apart in the longitudinal direction of the pressing member 330.

Also, a concave installation groove may be formed in the upper end of the pressing member 330 so that a lower end of the roller 332 is inserted thereinto, and the horizontal center of rotation of the roller 332 may be disposed inside the installation groove. Also, an impact absorbing member (rubber, etc.) (not illustrated) may be installed in a radial direction of the roller 332, and an outer peripheral surface of the impact absorbing member may be pressed against the prostate of the user 10.

When an upper end of the roller 332 is pressed against the prostate of the user 10 seated on the upper surface of the cushion part 100 and the reciprocating horizontal movement part 200 moves back and forth along both sides, since the roller 332 rotates in a direction opposite to the direction in which the pressing member 330 moves, there is an effect of pressing and rubbing the prostate of the user 10, and since friction acting on the upper end of the pressing member 330 may be reduced, the pressing member 330 may be easily moved.

Also, since the roller 332 moves back and forth while rotating in a state in which the upper end thereof is pressed against the prostate of the user 10, friction may be reduced, and thus a load acting when the pressing member 330 moves may be reduced. Since it is possible to reduce friction, damage to clothing of the user 10 may be prevented.

A motor for generating a rotational force may be used as the driving part 400. The driving part 400 may be installed in the installation space 111 of the housing 110 so as to be mechanically connected to the reciprocating horizontal movement part 200 by a power transmission member 410. When driven to rotate, the driving part 400 allows the reciprocating horizontal movement part 200 to move along both sides. Here, a driving shaft of the driving part 400 forms a horizontal center of rotation in a direction orthogonal to a direction in which the reciprocating horizontal movement part 200 moves.

The power transmission member 410 according to an embodiment of the present disclosure may include a first rotating shaft 411 disposed at one end of the reciprocating horizontal movement part 200 in the movement direction thereof and configured to form a horizontal center of rotation in a width direction of the reciprocating horizontal movement part 200, a connecting link 412 whose one side is connected to be movable back and forth in the longitudinal direction of the reciprocating horizontal movement part 200 by the first rotating shaft 411, a second rotating shaft 413 disposed at the other side that corresponds to the one side of the connecting link 412 and configured to form a horizontal center of rotation so as to be parallel to the first rotating shaft 411, and an eccentric bar 414 having one side connected to a driving shaft of the driving part 400 that is parallel to the second rotating shaft 413 and the other side, which is eccentric, rotatably connected to the second rotating shaft 413.

The first rotating shaft 411 forms the horizontal center of rotation in the direction orthogonal to the direction in which the reciprocating horizontal movement part 200 moves. The first rotating shaft 411 transmits a driving force transmitted from the connecting link 412, which will be described below, to the reciprocating horizontal movement part 200, and the reciprocating horizontal movement part 200 linearly moves back and forth along both sides due to the rotational force of the driving part 400.

The connecting link 412 may be disposed at one side of the reciprocating horizontal movement part 200 in the longitudinal direction thereof and may have a length in the direction in which the reciprocating horizontal movement part 200 moves. The connecting link 412 transmits a driving force transmitted from the eccentric bar 414, which will be described below, to the first rotating shaft 411.

The second rotating shaft 413 rotatably connects the connecting link 412 to the eccentric bar 414 which will be described below. The second rotating shaft 413 is disposed at one side of the connecting link 412 in the longitudinal direction thereof that is opposite to the first rotating shaft 411. The second rotating shaft 413 forms a horizontal center of rotation in the direction orthogonal to the direction in which the reciprocating horizontal movement part 200 moves.

The eccentric bar 414 is installed at the driving shaft of the driving part 400 so as to be eccentrically rotatable. One side of the eccentric bar 414 is coupled to the driving shaft of the driving part 400, and the other end of the eccentric bar 414 that is eccentrically rotatable is rotatably connected to one side of the connecting link 412 in the longitudinal direction thereof by the second rotating shaft 413.

When the driving shaft of the driving part 400 rotates, the eccentric bar 414 eccentrically rotates in the direction in which the reciprocating horizontal movement part 200 moves, and the connecting link 412, which is connected to one side of the eccentric bar 414 that eccentrically rotates, moves back and forth in the left-right direction. Here, due to the movement of the connecting link 412, the reciprocating horizontal movement part 200 moves back and forth in the left-right direction of the cushion part 100, and the acupressure part 300 installed at the upper end of the reciprocating horizontal movement part 200 horizontally moves back and forth in the left-right direction. In this way, the prostate of the user 10 is massaged.

The controller 500 is for controlling driving of the driving part 400. The controller 500 may be installed in the installation space 111 of the housing 110, and a manipulation part 510 for controlling the driving may be electrically connected to the controller 500.

The manipulation part 510 may be installed outside the cushion part 100 so as to be manipulated by the user. One or more manipulation switches may be disposed in the manipulation part 510 to allow the user to turn the driving on or off. A display part (an information display window, a lamp, etc.) configured to display various pieces of information to the outside may be disposed in the manipulation part 510.

Also, a manipulation switch through which an operation time of the driving part 400 may be set and a manipulation switch through which a rotational speed of the driving part 400 may be selected to control a movement speed of the acupressure part 300 may also be disposed in the manipulation part 510.

Also, as illustrated in FIG. 9, a detecting part 520 (a photoelectric sensor, a position sensor, etc.) configured to detect seating of the user may also be electrically connected to the controller 500. The detecting part 520 may be installed inside the installation space 111 to detect upward/downward movement of the insertion part 321. For example, the detecting part 520 may be installed at one side of the insertion part 321, and a target to be detected (a protrusion, a groove, etc.) may be formed at one side of the insertion part 321 to allow the detecting part 520 to detect an upward/downward movement position.

That is, in a state in which the power is turned on, the controller 500 may stop the driving of the driving part 400 when a user seating detection signal is not transmitted from the detecting part 520 and may resume the driving of the driving part 400 when the user seating detection signal is transmitted.

The power supply part 600 is for supplying power to the driving part 400. The power supply part 600 may be electrically connected to the controller 500 and installed inside the installation space 111. The power supply part 600 may use a rechargeable battery.

Here, a terminal part 610 configured to connect a terminal of a power cable (not illustrated) may be electrically connected to the power supply part 600, and the terminal part 610 may be installed in a state of being exposed to the outside of the cushion part 100 to allow the user to couple the terminal of the power cable. That is, the power cable may be connected to the terminal part 610 to charge the power supply part 600.

In another form, as illustrated in FIG. 6, a connector 620 capable of connecting the power supply part 600 to an outlet (not illustrated) may be connected to the power supply part 600 by a cable, and the connector 620 and the cable may extend to the outside of the cushion part 100. That is, the connector 620 may be connected to the outlet to supply power to the power supply part 600.

Hereinafter, an operation of the prostate massage apparatus according to an embodiment of the present disclosure will be described with reference to FIGS. 1 to 9.

When the manipulation switch of the manipulation part 510 is manipulated to drive the driving part 400, as illustrated in FIGS. 4 and 5, the eccentric bar 414 rotates along with the driving shaft of the driving part 400, and due to the eccentric rotation of the eccentric bar 414, the connecting link 412 moves back and forth in the left-right direction. Here, due to a driving force transmitted through the connecting link 412, the reciprocating horizontal movement part 200 moves back and forth in the left-right direction, and the acupressure part 300 horizontally moves back and forth along both left and right sides along with the reciprocating horizontal movement part 200.

In this process, the pressing member 330 horizontally moves back and forth in the left-right direction in a state in which the upper end of the pressing member 330 is pressed against the prostate of the user 10 seated on the cushion part 100, and due to a force acting on a lower portion of the pressing member 330, the insertion part 321 moves upward and downward, and simultaneously, the elastic member 340 is compressed and relaxed. Here, the pressing member 330 moves while moving upward/downward to a height that corresponds to the height of the prostate of the user 10 and presses the prostate of the user 10 upward due to a compressive elastic force of the elastic member 340.

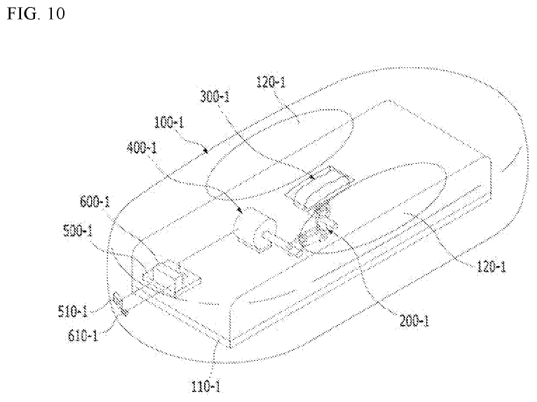

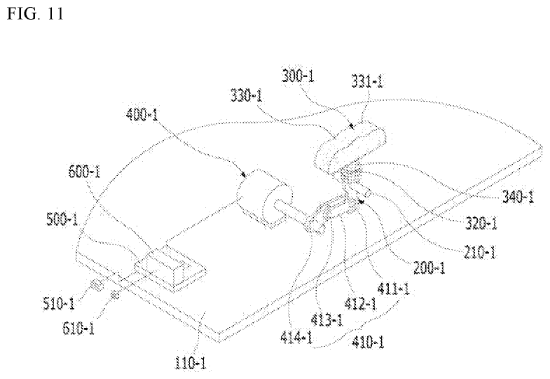

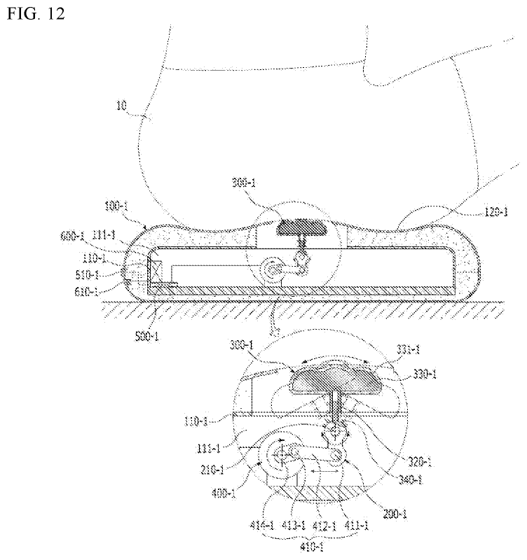

Therefore, since the pressing member 330 maintains a position at which the pressing member 330 is moved upward due to the compressive elastic force of the elastic member 340, the prostate of the user 10 may be intensively stimulated, and transmission of excessive pressure to the prostate of the user 10 may be prevented. FIG. 10 is a perspective view illustrating a prostate massage apparatus according to another embodiment of the present disclosure, FIG. 11 is a perspective view illustrating a reciprocating horizontal movement part, an acupressure part, and a driving part of the prostate massage apparatus according to the other embodiment of the present disclosure in detail, and FIG. 12 is a front cross-sectional view of the prostate massage apparatus according to the other embodiment of the present disclosure.

Referring to FIGS. 10 to 12, a prostate massage apparatus according to another embodiment of the present disclosure includes a cushion part 100-1, a swing part 200-1, an acupressure part 300-1, a driving part 400-1, a controller 500-1, and a power supply part 600-1.

The cushion part 100-1 is formed to have a certain area to allow a user 10 to sit thereon and may be filled with an elastic material (sponge, cotton, etc.) to have an elastic restoration force. An outer cover allowing the cushion part 100-1 to be coupled or separated may be disposed at an outer portion of the cushion part 100-1.

Here, an opening/closing part (a zipper, a buckle, etc.) (not illustrated) which is able to be opened and closed may be disposed at the outer cover of the cushion part 100-1. A space to which a housing 110-1 may be coupled may be formed inside the cushion part 100-1, and an installation space 111-1 may be formed to have a certain area inside the housing 110-1.

Also, a pair of seating grooves 120-1 having a shape that corresponds to buttocks of the user may be concavely formed on an upper surface of the cushion part 100-1 to allow the user to sit thereon. The seating groove 120-1 may be concavely formed in an elliptical shape, a hemispherical shape, or the like.

Also, an opening may be formed to vertically pass through a gap between the seating grooves 120-1 to allow a pressing member 330-1, which will be described below, to be exposed to an upper portion of the cushion part 100-1. That is, since the pressing member 330-1, which will be described below, is exposed to an upper portion of the opening, a pressing force of the pressing member 330-1 may be directly transmitted to the prostate of the user 10.

The swing part 200-1 is installed so that an upper end and a lower end thereof are able to move back and forth and rotate along both left and right sides with respect to a horizontal center of rotation inside the cushion part 100-1. A rotating shaft C is installed in a direction orthogonal to a rotational direction of the swing part 200-1 in the installation space 111-1, and the upper end and the lower end of the swing part 200-1 are able to move back and forth and rotate along both left and right sides with respect to the rotating shaft C.

The acupressure part 300-1 is installed to be movable upward and downward at an upper end of the swing part 200-1 and configured to move upward to a pressing position due to an elastic force of an elastic member 340-1 which will be described below. The acupressure part 300-1 presses the prostate of the user 10 seated on the cushion part 100-1 from below, and when the acupressure part 300-1 moves back and forth and rotates along both left and right sides along with the swing part 200-1, the height of the acupressure part 300-1 is changed to press the prostate.

The acupressure part 300-1 according to the other embodiment of the present disclosure may include an upward/downward movement member 320-1 coupled to the upper end of the swing part 200-1 so as to be movable upward and downward, the pressing member 330-1 coupled to an upper end of the upward/downward movement member 320-1 to press the prostate of the user 10 from below, and the elastic member 340-1 coupled to an outer portion of the upward/downward movement member 320-1 to allow a compressive elastic force to act between the pressing member 330-1 and the swing part 200-1.

The upward/downward movement member 320-1 has a lower end coupled to the upper end of the swing part 200-1 so as to be movable upward and downward. The lower end of the upward/downward movement member 320-1 and the upper end of the swing part 200-1 may be coupled to each other so as to be slidable upward and downward while being fitted to each other. For example, an upward/downward movement hole into which the upper end of the swing part 200-1 is vertically inserted may be formed in the lower end of the upward/downward movement member 320-1.

The pressing member 330-1 is coupled to the upper end of the upward/downward movement member 320-1 so as to be able to move back and forth and rotate along both left and right sides. The pressing member 330-1 may have a length in a rotational direction thereof. Here, an acupressure protrusion 331-1 configured to press the prostate of the user 10 may protrude upward from an upper end of the pressing member 330-1. The acupressure protrusion 331-1 may be provided as a plurality of acupressure protrusions 331-1 formed to be spaced apart in a longitudinal direction of the pressing member 330-1.

Also, protruding upper ends of the acupressure protrusions 331-1 may form a convex curvature in a rotational direction of the pressing member 330-1, and portions in between the acupressure protrusions 331-1 may form a concave curvature.

When the upper end of the pressing member 330-1 is pressed against the prostate of the user 10 seated on the upper surface of the cushion part 100-1 and the swing part 200-1 moves back and forth and rotates along both left and right sides, the pressing member 330-1 massages the prostate of the user 10 while moving in the left-right direction along with the swing part 200-1. Here, since the acupressure protrusions 331-1 protruding upward from the pressing member 330-1 horizontally move back and forth while pressing the prostate of the user 10, it is possible to maximize massage effects.

The elastic member 340-1 is coupled to an outer portion of the upward/downward movement member 320-1 to allow a compressive elastic force to act between the pressing member 330-1 and the swing part 200-1. The elastic member 340-1 may have the form of a coil spring to allow a compressive elastic force to act in the vertical direction. In this case, the elastic member 340-1 may have a lower end inserted in a state of being seated on the upper end of the swing part 200-1 and an upper end elastically supporting a lower end of the pressing member 330-1 upward.

A roller (not illustrated) which is rotatable with respect to a horizontal center of rotation may be disposed at the upper end of the pressing member 330-1. The horizontal center of rotation of the roller may be formed in a width direction of the pressing member 330-1, the roller may be installed to be rotatable in a direction in which the pressing member 330-1 horizontally moves, and the roller may be provided as a plurality of rollers installed to be spaced apart in the longitudinal direction of the pressing member 330-1.

Also, a concave installation groove (not illustrated) may be formed in the upper end of the pressing member 330-1 so that a lower end of the roller is inserted thereinto, and the horizontal center of rotation of the roller may be disposed inside the installation groove. Also, an impact absorbing member (rubber, etc.) (not illustrated) may be installed in a radial direction of the roller, and an outer peripheral surface of the impact absorbing member may be pressed against the prostate of the user 10.

When an upper end of the roller is pressed against the prostate of the user 10 seated on the upper surface of the cushion part 100-1 and the swing part 200-1 horizontally moves back and forth along both sides, since the roller rotates in a direction opposite to a direction in which the pressing member 330-1 moves, there is an effect of pressing and rubbing the prostate of the user 10, and since friction acting on the upper end of the pressing member 330-1 may be reduced, the pressing member 330-1 may be easily moved.

Also, since the roller moves while rotating in a state in which the upper end thereof is pressed against the prostate of the user 10, friction may be reduced, and thus a load acting when the pressing member 330-1 moves may be reduced. Since it is possible to reduce friction, damage to clothing of the user 10 may be prevented.

A motor for generating a rotational force may be used as the driving part 400-1. The driving part 400-1 may be installed in the installation space 111-1 of the housing 110-1 so as to be mechanically connected to the swing part 200-1 by a power transmission member 410-1. When driven to rotate, the driving part 400-1 allows the swing part 200-1 to move back and forth and rotate along both left and right sides. Here, a driving shaft of the driving part 400-1 forms a horizontal center of rotation in a direction orthogonal to a direction in which the swing part 200-1 rotates.

The power transmission member 410-1 according to the other embodiment of the present disclosure may include a first rotating shaft 411-1 configured to form a horizontal center of rotation at the lower end of the swing part 200-1, a connecting link 412-1 whose one side is connected to be rotatable in the rotational direction of the swing part 200-1 by the first rotating shaft 411-1, a second rotating shaft 413-1 disposed at the other side that corresponds to the one side of the connecting link 412-1 and configured to form a horizontal center of rotation so as to be parallel to the first rotating shaft 411-1, and an eccentric bar 414-1 having one side connected to a driving shaft of the driving part 400-1 that is parallel to the second rotating shaft 413-1 and the other side, which is eccentric, connected to be rotatable in a rotational direction of the connecting link 412-1 by the second rotating shaft 413-1.

The first rotating shaft 411-1 forms the horizontal center of rotation in the direction orthogonal to the rotational direction of the swing part 200-1. The first rotating shaft 411-1 transmits a driving force transmitted from the connecting link 412-1, which will be described below, to the swing part 200-1, and the swing part 200-1 linearly moves back and forth along both sides due to the rotational force of the driving part 400-1.

The connecting link 412-1 may be disposed at one side of the swing part 200-1 and may have a length in the rotational direction of the swing part 200-1.

The connecting link 412-1 transmits a driving force transmitted from the eccentric bar 414-1, which will be described below, to the first rotating shaft 411-1.

The second rotating shaft 413-1 rotatably connects the connecting link 412-1 to the eccentric bar 414-1 which will be described below. The second rotating shaft 413-1 is disposed at one side of the connecting link 412-1 in the longitudinal direction thereof that is opposite to the first rotating shaft 411-1. The second rotating shaft 413-1 forms a horizontal center of rotation in the direction orthogonal to the direction in which the swing part 200-1 moves.

The eccentric bar 414-1 is installed at the driving shaft of the driving part 400-1 so as to be eccentrically rotatable. One side of the eccentric bar 414-1 is coupled to the driving shaft of the driving part 400-1, and the other end of the eccentric bar 414-1 that is eccentrically rotatable is rotatably connected to one side of the connecting link 412-1 in the longitudinal direction thereof by the second rotating shaft 413-1.

When the driving shaft of the driving part 400-1 rotates, the eccentric bar 414-1 eccentrically rotates in the rotational direction of the swing part 200-1, and the connecting link 412-1, which is connected to one side of the eccentric bar 414-1 that eccentrically rotates, moves in the left-right direction. Here, due to the movement of the connecting link 412-1, the swing part 200-1 rotates in the left-right direction of the cushion part 100-1, and the acupressure part 300-1 installed at the upper end of the swing part 200-1 moves back and forth and rotates in the left-right direction. In this way, the prostate of the user 10 is massaged.

The controller 500-1 is for controlling driving of the driving part 400-1. The controller 500-1 may be installed in the installation space 111-1 of the housing 110-1, and a manipulation part 510-1 for controlling the driving may be electrically connected to the controller 500-1.

The manipulation part 510-1 may be installed outside the cushion part 100-1 so as to be manipulated by the user. One or more manipulation switches may be disposed in the manipulation part 510-1 to allow the user to turn the driving on or off. A display part (an information display window, a lamp, etc.) configured to display various pieces of information to the outside may be disposed in the manipulation part 510-1.

Also, a manipulation switch through which an operation time of the driving part 400-1 may be set and a manipulation switch through which a rotational speed of the driving part 400-1 may be selected to control a movement speed of the acupressure part 300-1 may also be disposed in the manipulation part 510-1.

Also, a detecting part (a photoelectric sensor, a position sensor, etc.) configured to detect seating of the user may also be electrically connected to the controller 500-1. The detecting part may be installed inside the installation space 111-1 to detect upward/downward movement of the upward/downward movement member 320-1. For example, the detecting part may be installed at one side of the upward/downward movement member 320-1, and a target to be detected (a protrusion, a groove, etc.) may be formed at one side of upward/downward movement member 320-1 to allow the detecting part to detect an upward/downward movement position.

That is, in a state in which the power is turned on, the controller 500-1 may stop the driving of the driving part 400-1 when a user seating detection signal is not transmitted from the detecting part and may resume the driving of the driving part 400-1 when the user seating detection signal is transmitted.

The power supply part 600-1 is for supplying power to the driving part 400-1. The power supply part 600-1 may be electrically connected to the controller 500-1 and installed inside the installation space 111-1. The power supply part 600-1 may use a rechargeable battery.

Here, a terminal part 610-1 configured to connect a terminal of a power cable (not illustrated) may be electrically connected to the power supply part 600-1, and the terminal part 610-1 may be installed in a state of being exposed to the outside of the cushion part 100-1 to allow the user to couple the terminal of the power cable. That is, the power cable may be connected to the terminal part 610-1 to charge the power supply part 600-1.

In another form, a connector capable of connecting the power supply part 600-1 to an outlet (not illustrated) may be connected to the power supply part 600-1 by a cable, and the connector and the cable may extend to the outside of the cushion part 100-1. That is, the connector may be connected to the outlet to supply power to the power supply part 600-1.

Hereinafter, an operation of the prostate massage apparatus according to the other embodiment of the present disclosure will be described with reference to FIGS. 10 to 12.

When the manipulation switch of the manipulation part 510-1 is manipulated to drive the driving part 400-1, the eccentric bar 414-1 rotates along with the driving shaft of the driving part 400-1, and due to the eccentric rotation of the eccentric bar 414-1, the connecting link 412-1 moves back and forth in the left-right direction. Here, due to a driving force transmitted through the connecting link 412-1, the swing part 200-1 rotates in the left-right direction about a rotating shaft 210-1, and accordingly, the acupressure part 300-1 at the opposite side moves back and forth and rotates in the left-right direction along with the swing part 200-1.

In this process, the pressing member 330-1 moves back and forth and rotates in the left-right direction in a state in which the upper end of the pressing member 330-1 is pressed against the prostate of the user 10 seated on the cushion part 100-1, and due to a force acting on a lower portion of the pressing member 330-1, the upward/downward movement member 320-1 moves upward and downward, and simultaneously, the elastic member 340-1 is compressed and relaxed. Here, the pressing member 330-1 rotates while moving upward/downward to a height that corresponds to the height of the prostate of the user 10 and presses the prostate of the user 10 upward due to a compressive elastic force of the elastic member 340-1.

As a result, according to the present disclosure, it is possible to perform a massage operation in which the prostate (perineal region) is rubbed while being pressed with a certain pressure. Thus, acupoints may be relieved to improve circulation, and genital diseases such as prostatitis, perineal pain, groin pain, lower abdominal pain, and sexual dysfunction may be prevented and treated.

Also, according to the present disclosure, a pressing member moves in a state of being elastically supported. Thus, the prostate does not receive excessive pressure, and pain and side effects do not occur. Also, the perineal region associated with the prostate may be massaged. Thus, the amount of blood flow to the prostate and penis may be increased to improve erection and ejaculation abilities.

Due to being capable of performing a massage operation in which a prostate (perineal region) is rubbed while being pressed with a certain pressure, there are advantageous effects in that circulation can be improved by relieving acupoints, and genital diseases such as prostatitis, perineal pain, groin pain, lower abdominal pain, and sexual dysfunction can be prevented and treated.

Also, according to the present disclosure, there are advantageous effects in that, since a pressing member moves in a state of being elastically supported, transmission of excessive pressure to the prostate does not occur, thus not causing pain and side effects, and since a perineal region associated with the prostate can be massaged, the amount of blood flow to the prostate and penis can be increased, thus improving erection and ejaculation abilities.

Specific embodiments relating to the prostate massage apparatus according to the present disclosure have been described above, but it should be apparent that various modifications are possible within the scope not departing from the scope of the present disclosure.

Therefore, the scope of the present disclosure should not be defined as being limited to the embodiments described herein and should be defined by the attached claims and their equivalents.

That is, the embodiments described herein should be understood as being illustrative, instead of limiting, in all aspects. The scope of the present disclosure is shown by the attached claims rather than by the detailed description above, and all changes or modifications derived from the meaning and scope of the claims and their equivalents should be interpreted as belonging to the scope of the present disclosure.

1.-6. (canceled)

7. A prostate massage apparatus comprising:
a cushion part on which a user is able to sit;
a reciprocating horizontal movement part installed to be horizontally movable along both sides inside the cushion part;
an acupressure part installed to be movable upward and downward at an upper end of the reciprocating horizontal movement part and configured to move upward to a pressing position due to an elastic force of an elastic member; and
a driving part mechanically connected to the reciprocating horizontal movement part by a power transmission member inside the cushion part and configured to, when driven to rotate, allow the reciprocating horizontal movement part to move back and forth along both sides,
wherein the acupressure part elastically supports the prostate of the user seated on the cushion part from below, and when the acupressure part moves along both sides along with the reciprocating horizontal movement part, the height of the acupressure part is changed to press the prostate,
the acupressure part includes a pair of upward/downward movement holes each formed in an upper end of the reciprocating horizontal movement part in a movement direction thereof, an upward/downward movement member including a pair of insertion parts inserted into each upward/downward movement hole so as to be movable upward and downward and a connecting part configured to horizontally connect upper ends of the insertion parts, a pressing member coupled to an outer portion of the connecting part to press the prostate from below, and the elastic member coupled to an outer portion of the insertion part to allow a compressive elastic force to act between the connecting part and the reciprocating horizontal movement part,
the upward/downward movement hole is vertically formed, a step is formed at an inner peripheral surface of the upward/downward movement hole, the insertion part has a vertical length, a catching protrusion that protrudes sideward is formed on a lower end of the insertion part, and, when the upward/downward movement member is maximally moved upward, the catching protrusion is caught at a lower end of the step formed at the inner peripheral surface of the upward/downward movement hole, and
a roller which is rotatable with respect to a horizontal center of rotation is disposed at an upper end of the pressing member, the roller is installed to be rotatable in a direction in which the pressing member horizontally moves, a concave installation groove is formed in the upper end of the pressing member so that a lower end of the roller is inserted thereinto, and the horizontal center of rotation of the roller is disposed inside the installation groove.

8. The prostate massage apparatus of claim 7, wherein an acupressure protrusion configured to press the prostate protrudes from an outer peripheral surface of the pressing member, and the acupressure protrusion is provided as a plurality of acupressure protrusions arranged to be spaced apart in a direction in which the pressing member moves.

9. The prostate massage apparatus of claim 7, wherein a guide part configured to slidably support an outer portion of the reciprocating horizontal movement part is further disposed inside the cushion part.

10. The prostate massage apparatus of claim 7, wherein the power transmission member includes:
a first rotating shaft disposed at one end of the reciprocating horizontal movement part in the movement direction thereof and configured to form a horizontal center of rotation in a width direction of the reciprocating horizontal movement part;
a connecting link whose one side is connected to be rotatable in a longitudinal direction of the reciprocating horizontal movement part by the first rotating shaft;
a second rotating shaft disposed at the other side that corresponds to the one side of the connecting link and configured to form a horizontal center of rotation so as to be parallel to the first rotating shaft; and
an eccentric bar having one side connected to a driving shaft of the driving part that is parallel to the second rotating shaft and the other side, which is eccentric, connected to be rotatable in a rotational direction of the connecting link by the second rotating shaft.

11. The prostate massage apparatus of claim 7, further comprising:
a controller electrically connected to the driving part to control driving; and
a power supply part electrically connected to the controller to supply power thereto.
